(19) United States
(12) Patent Application Publication
(10) Pub. No.: US 2006/0244168 A1
(43) Pub. Date: Nov. 2, 2006

(54) Method and device for orienting magnetizable particles in a kneadable material

(76) Inventor: Shunli Zhang, Veldhoven (NL)

Correspondence Address: DEWITT ROSS & STEVENS S.C., 8000 EXCELSIOR DR, SUITE 401, MADISON, WI, 53717-1914, US

(21) Appl. No.: 10/558,060

(22) PCT Filed: May 13, 2004
(86) PCT No.: PCT/EP04/05114

§ 371 Date: May 12, 2006

(30) Foreign Application Priority Data
May 22, 2003 (EP) 03011664.4
Jun. 27, 2003 (EP) 03014707.8
Dec. 23, 2003 (EP) 03029732.9

(51) Int. Cl. B29C 67/00; B28B 17/00

(52) U.S. Cl. 264/108; 264/437; 425/3

(57) ABSTRACT

The invention relates to a method and device for orienting magnetisable particles (4) in a kneadable material (3), in particular steel fibres or rings in unhardened concrete by means of an orienting body (1) provided with a non-magnetic wall comprising a front face section (1a) and a rear face section (1b). A kneadable material (33) and the front face section (1a) of the orientation body (1) are first and foremost displaced with respect to each other. The orientation body (1) is also provided with a magnetic unit (2) which is disposed on the internal side of said front face section (1a) and generates a periodically variable magnetic field acting on the kneadable material in order to orient the magnetisable particles (4). Said invention is characterised in that said magnetic field is divided into at least two areas (III) containing the partial fields exhibiting different forces and/or different directions of force lines. The partial field of the first area (I) applies long trajectory orientation and attractive forces on the particles, the partial field of the second area (II) releasing orientedly positioned particles.

The invention relates to a device for aligning magnetisable particles in a paste-like material, having an aligning body with a wall comprising a front surface section and a rear surface section, the paste-like material and the aligning body with its front surface section foremost being movable relative to each other, the aligning body furthermore having a magnet unit which is arranged inside the aligning body on the inside of the front surface section and which generates a periodically varying magnetic field acting on the paste-like material in order to align the magnetisable particles. The invention also relates to a method for aligning magnetisable particles in a paste-like material.

The use of steel fibres in concrete in order to reinforce it has been known for about 20 years. In this case, the steel fibres are distributed uniformly in the concrete over its volume with a random alignment. In a concrete slab loaded in flexion, for example, it is desirable for the fibres to be distributed in a plane perpendicular to the bending force which acts, so that they can reinforce the concrete body maximally according to its load. Those fibres which are arranged obliquely or even parallel to the force acting contribute only less or not at all to this reinforcing effect. In a concrete body having steel fibres aligned in the desired way, compared with concrete bodies having irregularly distributed steel fibres, their dosing can therefore be reduced without significantly impairing the specific load response of the concrete body.

Besides the advantage of selective structural reinforcement of the respective concrete component by aligning the fibres which it contains, for example in industrial flooring, further applications of such concrete components are also conceivable. By aligning the steel fibres in a plane, for example, it is possible to generate an electrically conductive layer in a concrete wall, so that this can be heated or electromagnetic screening can be produced.

The prior art of laid-open US patent application US 2002/0182395 A1 and published international application WO/9967072 discloses a method and a device for aligning magnetisable fibres in a viscous body, particularly steel fibres in unset concrete. The device consists of an aligning body designed as a hollow profile, which itself consists of a nonmagnetisable material. The aligning body has a front surface section in the shape of a circle arc in cross section, which converges sharply in a straight line via two flank sections in the direction of a rear surface section. Arranged in the aligning body, concentrically with the front surface section in the shape of a circle arc, there is a rotatably mounted roller which has one or more permanent magnets on its outer circumferential surface, in particular three arranged with a mutual separation of 120° each. The gap between the inside of the front surface section and the circumferential surface of the roller is minimised since the radius of the roller is only slightly less than the radius of curvature of the front surface section. By rotating the magnetic roller, a rotating magnetic field is generated which penetrates through the nonmagnetic wall of the aligning body and acts on the material around the aligning body.

According to the method indicated for aligning the fibres in the unset concrete, the device i.e. the aligning body with a rotating roller is moved transversely to its longitudinal axis through the concrete body, or the paste-like concrete containing the fibres to be aligned is moved relative to the stationary aligning body, so that the concrete flows around the aligning body along its curved front surface section. Owing to the magnetic field generated by the permanent magnets arranged on the rotating roller, the fibres encountering the front surface section are moved around the aligning body according to the rotation direction of the roller. At the transition from the circularly curved front surface section into the straight flank section, the magnetic field of the rotating magnets becomes much weaker on the wall of the aligning body since they are further away from the wall. The fibres consequently remain in the aligned position. Owing to the continuous relative motion between the concrete and the aligning body, a layer of aligned fibres is therefore formed along the path travelled by the aligning body relative to the concrete.

According to a special embodiment of the known device, a substantially smaller second magnetic roller is arranged inside the magnetic roller in addition to it, in the region of the transition from the front surface section into the flank section. The arrangement of the magnet present on the second roller and the ratio of the diameters of the two rollers to each other is selected so that the magnetic field of the first roller guiding the fibres around the front surface section is screened outwards, i.e. in the direction of the fibres, to some degree in the region of the second roller so that the release of the aligned fibres at the intended position is improved.

A disadvantage with the described device, and with the method carried out using this device, is that only fibres in the immediate vicinity of the device can be aligned, so that fibres lying further away keep their irregular alignment. Furthermore, the alignment of the fibres is not optimal owing to the comparatively high residual field strength at the release position. Although simply increasing the magnetic field strength by using stronger magnets would increase the range of the magnetic field to a limited extent, this would nevertheless significantly reduce the quality of the layer structure owing to inferior release of the aligned particles.

It is therefore an object of the invention to refine the prior art device so that more selective alignment of a substantially larger number of particles contained in a paste-like material is possible. It is also an object for the device to be produced without great technical outlay and cost. Further objects of the invention can be found in the following description of the invention and the exemplary embodiments.

The aforementioned object is achieved by a device of the type mentioned in the introduction, in that the magnetic field is divided into at least two zones having sub-fields of different field strength and/or field line profile, the sub-field of the first zone exerting a long-range attracting and aligning force on the particles and the sub-field of the second zone releasing the particles in the aligned position.

The effect achieved by dividing the magnetic field generated by the magnet unit according to the invention into at least two zones having sub-fields of different field strength and/or field line profile, on the one hand, is that even the particles which are at a comparatively large distance from the aligning body are aligned. On the other hand, the effect achieved by the sub-field of the second zone is that the particles are released precisely at the position intended for this on the wall of the aligning body so that, for example, a layer to be formed by aligned particles in the paste-like material is provided with the desired properties, in particular a high fibre density in the layer plane together with a minimal layer thickness.

The aligning body provided according to the invention may consist of any material. Nonmagnetic materials are particularly suitable since they do not hinder the release of the aligned particles on the wall of the aligning body at the position intended for this owing to their own magnetic field.

With respect to the attracting force generated by the sub-field of the first zone, which acts on the particles to be aligned, its range can be adjusted by appropriate selection of the field strength and the field line profile of the sub-field in this zone. The proportion of the particles in the paste-like material which are intended to be co-aligned by the device according to the invention, or the proportion of the particles which are still intended to remain with an irregular alignment in the material, can thus be adjusted exactly. The material properties of the paste-like material, for example its viscosity or the size and shape of other fillers which it contains, will likewise be taken into account in this case.

The field line profile in the magnet unit can be adjusted in various ways. One advantageous adjustment consists in the field lines of the magnetic field of the magnet unit extending only in a plane perpendicular to the relative motion between the aligning body and the paste-like material. Alignment of the particles therefore takes place only in this plane. Consequently, the particles can be released very easily at the position intended for this on the wall of the aligning body, since this does not involve the formation of a network of magnetised particles along the direction of the relative motion, which would cause strong coalescence between the magnetised particles and therefore make them difficult to release.

Another way of adjusting the field line profile consists in the field lines extending in a plane parallel to the relative motion between the aligning body and the paste-like material. In fact, the aforementioned network formation does then take place. Nevertheless, this can be effectively countered by a particularly variably configurable field line profile. In this case, for example, it is possible to divide the magnetic field of the magnet unit into three zones having sub-fields of different field strength and/or different field line profile, the sub-field of the first zone exerting a long-range attracting force on the particles, that of the second zone exerting a holding force on the particles by which they are aligned, and that of the third zone releasing the particles in the aligned position. On the one hand, dividing the magnetic field into three zones still ensures the alignment of particles lying relatively far away from the aligning body, and on the other hand they will be aligned particularly precisely by the moderate holding force generated by the sub-field of the second zone, and finally released by the sub-field of the third zone after reaching the desired position in the paste-like material. This division of the magnetic field consequently means that the quality of the particle alignment, and their controlled release at the position intended for this, are not impaired despite the strong long-range attracting force of the sub-field of the first zone.

In a particularly preferred embodiment of the device, the field line profile of the magnetic field of the magnet unit is composed of a combination of components which extend in a plane perpendicular to the relative motion between the aligning body and the paste-like material, and components which extend parallel to the relative motion. This type of combined field line profile makes it possible, in particular, for the aligned particles to be distributed particularly uniformly in the target volume, and for them no longer to have any tendency towards clumped accumulation along those field lines which extend only parallel or perpendicularly to the relative motion between the aligning body and the paste-like material. Furthermore, consistency of the aligning process as a function of position and time can be achieved even if the relative speed between the aligning body and the paste-like material and the frequency of the periodically varying magnetic field are not optimally matched to each other.

In particular, two solutions have been found to be particularly advantageous for dividing the magnetic field generated by the magnet unit, whose field lines extend in a plane parallel to the relative motion between the aligning body and the paste-like material, into the different zones. On the one hand, the first and second zones may each cover approximately a 90° region and the third zone may cover an approximately 180° region of the cross section of the magnet unit. Nevertheless, approximately 120° coverage of the cross section of the magnet unit by each of the three zones is also expedient.

In particular, the device may be produced without excessive technical outlay and costs if the magnet unit generating the periodically varying magnetic field is designed as a rotating body with a static field distribution. As already found in the prior art, the aligning body is advantageously designed as a hollow profile, extending transversely to the direction of the relative motion between the aligning body and the paste-like material, the cross section of which converges as a support surface cross section from the essentially semicircularly curved front surface section, tapering via two flank surfaces to the rear surface section. This shape favours, on the one hand, the alignment of the particles as they are transported along the curved surface and, on the other hand, their controlled release at the transition between one end of the front surface section and a flank surface.

Designing the magnet unit as a rotating cylindrical roller whose rotation axis coincides with the mid-axis of the semicircularly curved front surface section, minimises the gap between the inside of the front surface section of the aligning body and the magnetic roller, so that its magnetic field can act with low losses on the paste-like material around the aligning body. The magnetic roller in this case expediently extends over the entire length of the aligning body. Correspondingly, the field lines lying in a plane parallel to the relative motion between the aligning body and the paste-like material extend in the axial direction of the magnetic roller, whereas the field lines lying in a plane parallel to the relative motion extend in the circumferential direction of the magnetic roller.

High variability in the shaping of the magnetic field formed by the three sub-fields is obtained if it is generated by permanent magnets. Particularly high field strengths can be generated by permanent magnets made of an NdFeB alloy. To this end, it is expedient for at least one of the permanent magnets to consist of this alloy.

In the case of a magnetic field divided into three zones, the function of the third zone of the magnetic field is to release the particles in the aligned position. This can be achieved particularly effectively if the sub-field of the third zone is generated by a soft magnetic material, particularly a low-carbon steel. This leads to a return flux of the magnetic field lines which is spatially restricted to the soft magnetic material, so that the field strength of the magnetic field almost vanishes radially outside this zone and the particles no longer experience virtually any attracting force in this region.

It is also an object of the invention to provide an improved method for aligning magnetisable particles in a paste-like material.

The object is achieved by a method using the device described above. The advantages of this device apply equally to the method according to the invention. In particular, it has a wide range of application when unset concrete is used as the paste-like material and the particles are designed as steel fibres.

Alternatively, the particles may also be designed as steel rings. Their use is found to be particularly advantageous when, for example, a thin layer is intended to be generated in a concrete slab loaded in flexion. Using steel rings then achieves a particularly high degree of overlap of the individual particles in the layer plane, so that the effectiveness of the structural reinforcement is increased. Compared with the use of conventional one-dimensionally shaped steel shavings or fibres, this makes it possible inter alia to reduce the consumption of material without noticeably impairing the load response of the reinforced component.

The invention will be explained in more detail below with reference to a drawing which represents merely exemplary embodiments, in which:

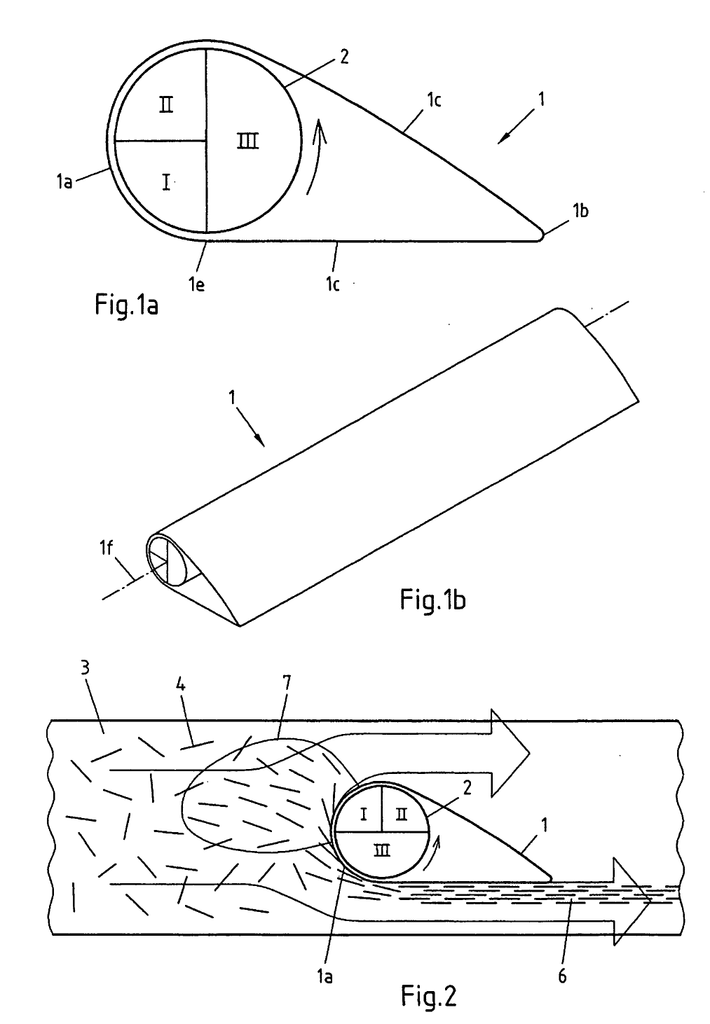

FIGS. 1a,b show a device for aligning magnetisable particles in a paste-like material by a schematic representation in cross section and perspective,

FIG. 2 shows the functional principle of the device in FIG. 1 by a schematic representation,

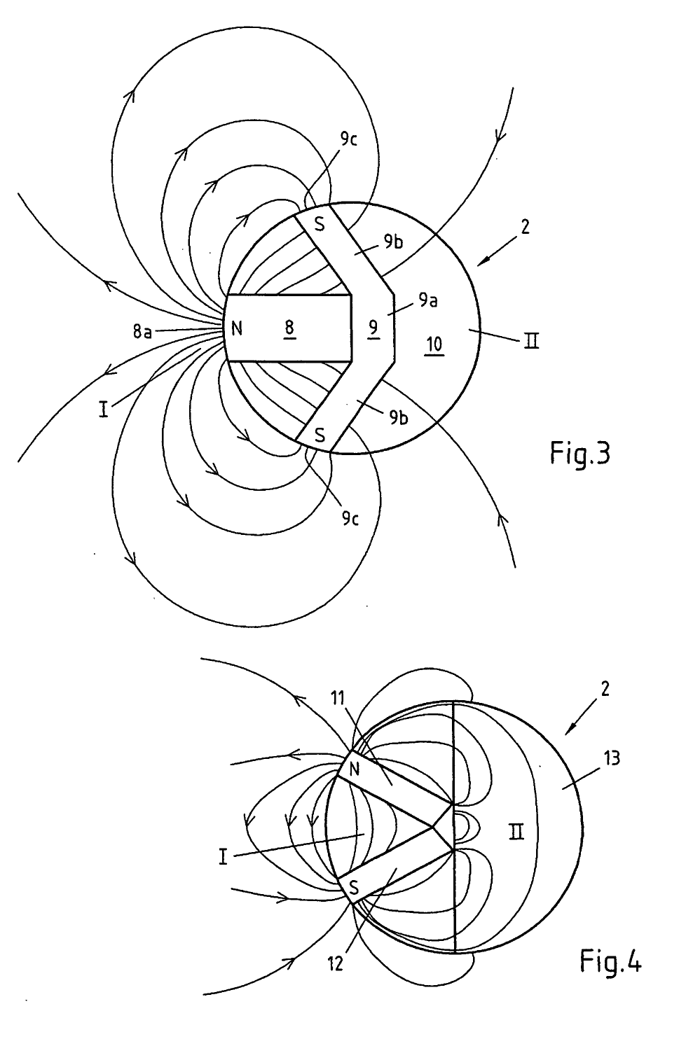

FIG. 3 shows the magnet unit of the device in FIG. 1 with a tripole arrangement,

FIG. 4 shows the magnet unit of the device in FIG. 1 with a dipole arrangement having a radial magnet alignment,

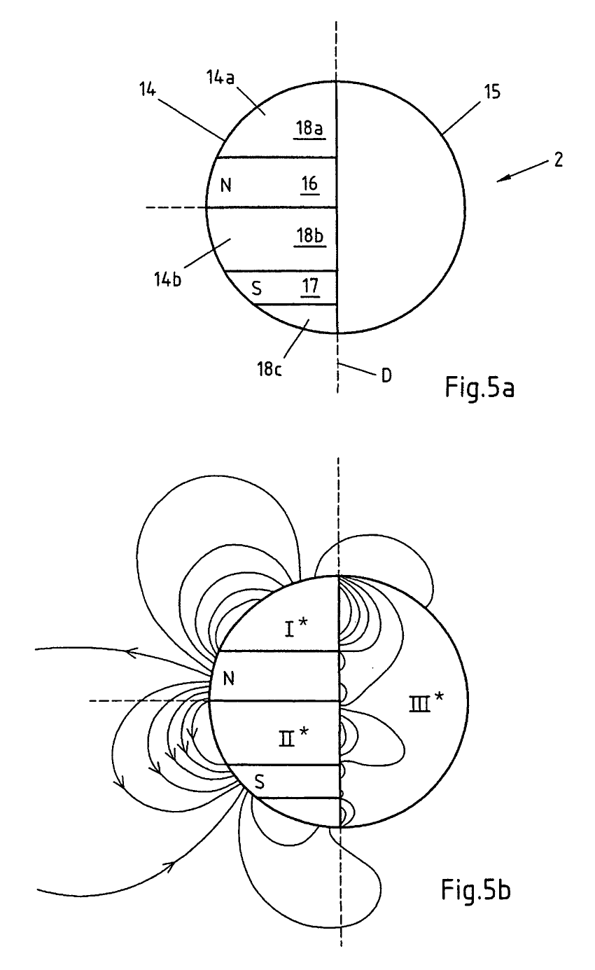

FIGS. 5 a,b show the magnet unit of the device in FIG. 1 with an asymmetric magnet arrangement,

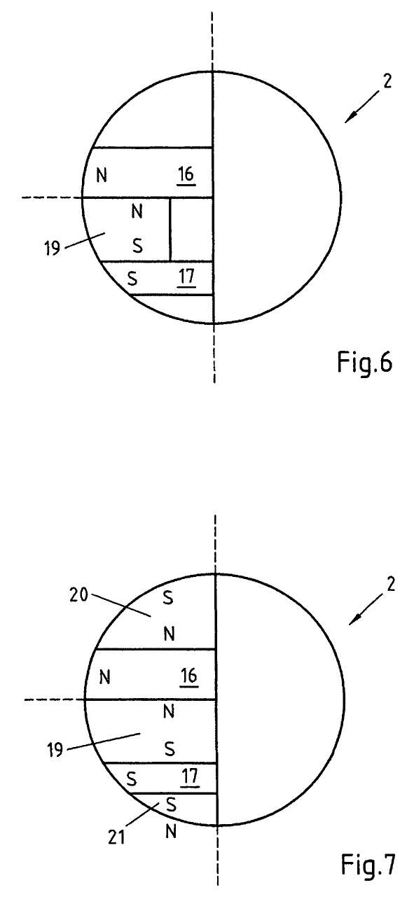

FIG. 6 shows the magnet unit of the device in FIG. 1 with an asymmetric magnet arrangement having a Bucking pole,

FIG. 7 shows the magnet unit of the device in FIG. 1 with an asymmetric magnet arrangement having a linear Halbach array,

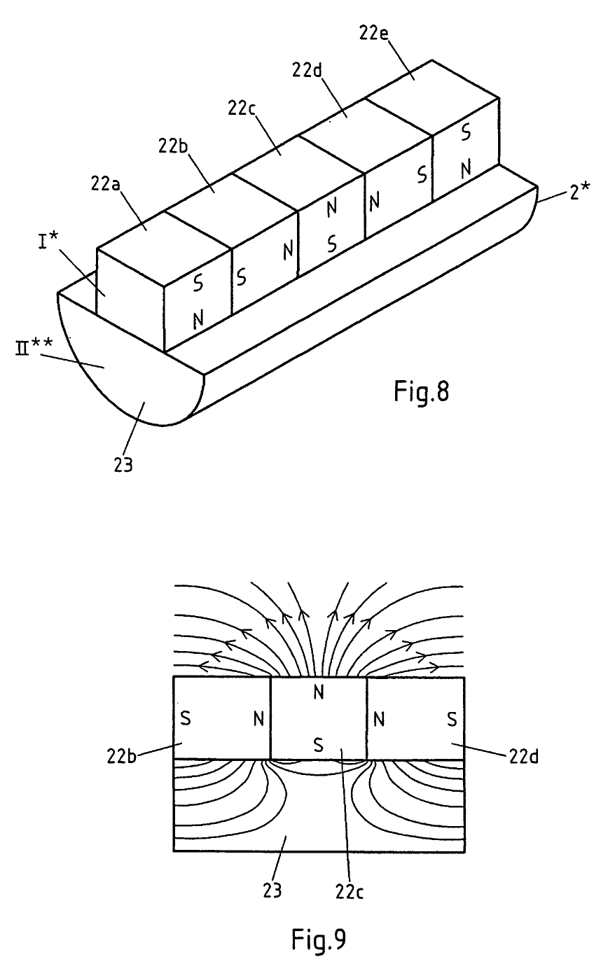

FIG. 8 shows the magnet unit of the device in FIG. 1 in an alternative embodiment with an axially aligned linear Halbach array,

FIG. 9 shows the field line profile in the magnet unit of FIG. 8 as a detail,

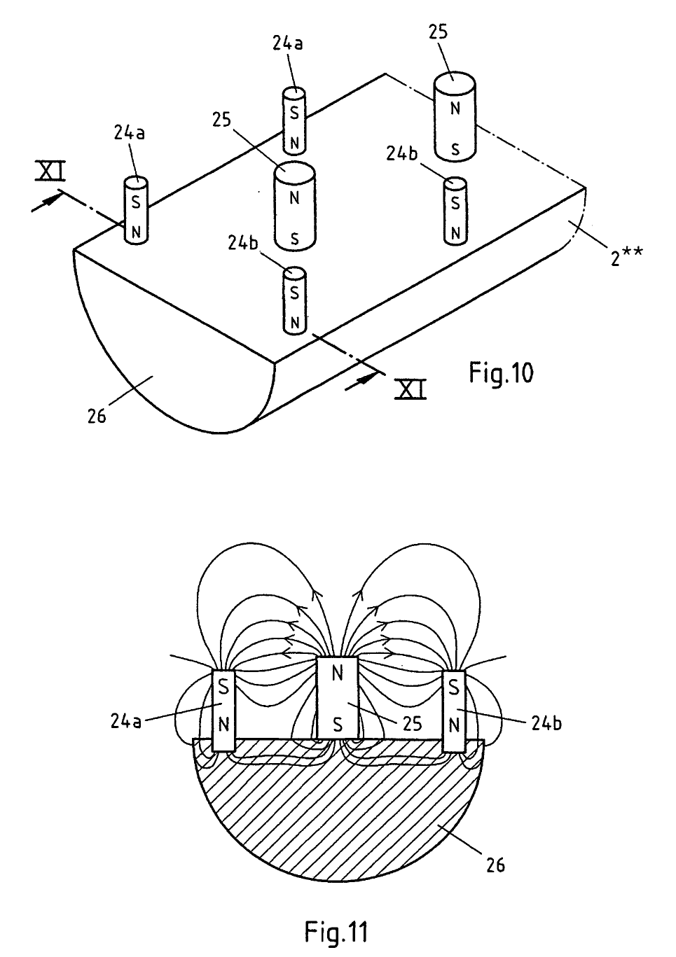

FIG. 10 shows the magnet unit of the device in FIG. 1 in another alternative embodiment with a combined radially and axially offset arrangement of the magnets as a detail and

FIG. 11 shows the magnet unit of FIG. 10 in cross section along the line XI-XI of FIG. 10 with the field line profile indicated.

FIGS. 1a and 1b represent a device for aligning magnetic particles in a paste-like material. The device has an aligning body 1 in the form of a hollow profile, which consists of a nonmagnetic material. According to the cross-sectional view of FIG. 1a, the hollow profile comprises a front surface section 1a in the shape of a circle arc, which converges sharply in a straight line via two flank sections 1c in the direction of a rear surface section 1b. Arranged inside the aligning body 1, there is a magnet unit 2, which is designed as a rotatably mounted cylindrical roller concentric with the front surface section 1a in the shape of a circle arc. The magnetic roller 2 is equipped with permanent magnets along its longitudinal axis and is rotated, for example, by one or more electric motors (not shown). A rotating i.e. periodically varying magnetic field acting on the particles contained in.the paste-like material is therefore generated, which is divided into three zones I, II, III having sub-fields of different field strength and/or different field line profile. The first and second zones each cover a 90° region and the third zone covers the remaining 180° region of the circular cross section of the magnet unit. The radius of the magnetic roller 2 is only slightly less than the radius of curvature of the front surface section 1a, so that the gap between the inside of the front surface section 1a and the circumferential surface of the magnetic roller 2 is minimal and the magnetic field of the magnetic roller 2 can act with low losses on the paste-like material around the aligning body 1.

An alternative embodiment of the magnet unit, according to which it is arranged fixed in the aligning body and the periodically varying magnetic field is produced by arranging individually driveable electromagnets inside the aligning body, is not represented.

The functional principle of the device is schematically represented in FIG. 2. Accordingly, the aligning body 1 with the rotating magnetic roller 2 arranged in it is moved transversely to its longitudinal axis if through a paste-like material 3 in the form of an unset concrete layer, which contains magnetisable particles 4 in the form of steel fibres or steel rings. The paste-like concrete 3 may also be moved relative to the stationary aligning body 1. In both cases, the concrete 3 flows around the aligning body 1 along its curved front surface section la. During this, the magnetic roller 2 rotates anticlockwise so that the magnetisable particles 4 become arranged as described below in a layer 6 underneath the aligning body 1. As can be seen clearly in FIG. 2, the field lines extend in a plane parallel to the relative motion between the aligning body 1 and the paste-like material 3.

The sub-field of the first zone I exerts a long-range attracting force on the steel fibres 4, so that the fibres 4 in an elongate region 7 before the front surface section 1a of the aligning body 1 move towards the latter. The sub-field of the second zone II exerts a holding force on the attracted particles 4, by which they are transported down along the front surface section la according to the rotation direction of the magnetic roller 2 while being aligned. The sub-field of the third zone III, the field strength of which almost vanishes radially outside the aligning body 1 owing to the closed magnetic field lines inside this zone, releases the particles 4 in the aligned position approximately at the point 1e of the transition from the circularly curved front-surface section 1a into the lower flank section 1c.

The rotation of the overall magnetic field of the magnetic roller 2, composed of the three sub-fields, means that the sub-field of the first zone I also acts regularly at the point where the particles 4 are released. The detachment of the particles from the wall of the aligning body 1 is therefore regularly impeded temporarily, which would lead to an undesired corrugated structure of the particle layer 6 to be formed. This can be effectively countered, however, if the rotation frequency of the magnetic roller is selected to be very high relative to the motion of the aligning body 1 in the concrete layer, so that any corrugated structure of the layer 6 is smoothed out.

FIGS. 3-7 represent various arrangements of the permanent magnets in the magnetic roller 2.

According to FIG. 3, a strong permanent magnet 8, preferably consisting of an NdFeB alloy, extends radially outwards from a point near the rotation axis of the magnetic roller 2. Its outer end face 8a, where the magnetic north pole is located, is in this case shaped according to the curvature of the magnetic roller so that the magnetic roller can rotate with a minimum gap from the inner face of the front surface section 1a of the aligning body 1. A pole piece 9 made of a soft magnetic material, preferably a soft unalloyed steel, is furthermore provided inside the magnetic roller 2. The pole piece 9 comprises a central section 9a which adjoins flush with the inner end face of the permanent magnet 8 where its magnetic south pole is located, and surrounds the rotation axis of the magnetic roller 2. An end section 9b respectively protrudes from each side of the central section 9a. The two end sections 9b are angled off slightly in the direction of the permanent magnet 8 and extend as far as the outer circumference of the magnetic roller 2, their respective outer end faces 9c being matched just like the circumferential curvature of the magnetic roller.

The magnetic field generated by this magnet arrangement is divided into two zones I, II and is graphically represented by its field lines. The first zone I is formed by the permanent magnet 8 and the pole piece 9. The pole piece 9 is in this case magnetised by the strong permanent magnet 8, so that a magnetic south pole is formed on each of its end sections 9b. Accordingly, the field lines extend from the north pole of the permanent magnet 8 through the space around the magnetic roller, or the aligning body which encloses it, to the end sections 9b of the pole piece 9, the consequence of which is that the region 10 of the magnetic roller lying towards the rear with respect to the magnet arrangement, which forms the second zone II and may for example be filled with aluminium or steel, is permeated by a field of only low field strength. The field generated by the north pole of the permanent magnet 8 exerts an attracting force, in particular on magnetisable material which lies in a region in extension of its longitudinal axis. The magnet arrangement according to FIG. 3 is distinguished in particular by little manufacturing outlay and therefore low costs.

The magnet arrangement according to FIG. 4 comprises two permanent magnets 11, 12 of essentially equal size and strength, extending radially outwards from the rotation axis of the magnetic roller 2. The two magnets 11, 12 preferably consist of an NdFeB alloy. The magnets 11, 12 are at an acute angle of approximately 60° with respect to each other and extend approximately from the rotation axis of the magnetic roller 2 to its circumferential surface, the outer end faces of the magnets 11, 12 again being matched to the circumferential curvature of the magnetic roller 2 in order to minimise the size of the gap between the magnetic roller and the front surface section of the aligning body (not indicated here). The two magnets 11, 12 are oppositely aligned, so that the north pole points outwards in the case of the first magnet 11 and the south pole points outwards in the case of the second magnet 12.

On the other side of the rotation axis of the magnetic roller 2, at an equal angular spacing from the two magnets 11, 12, there is a region 13 consisting of a soft magnetic material, preferably a soft unalloyed steel, which extends over 180° and therefore over half the cross-sectional area of the magnetic roller 2.

The magnetic field generated by this magnet arrangement is again divided into two zones I, II and is visualised by its field line profile. The sub-field of the first zone is generated by the angularly arranged magnets 11, 12. Their opposite alignment generates a magnetic field which extends deep into space and therefore exerts a far-reaching attracting force. The region 13 arranged towards the rear, consisting of the soft magnetic material, represents the second zone II in which the field lines are fed back almost completely. The residual field strength in the region externally around the second zone is therefore vanishingly small, which is a prerequisite for the possibility of releasing the attracted and aligned particles in the desired position.

The asymmetric magnet arrangement of the magnetic roller 2 represented in FIG. 5 generates a magnetic field divided into three zones I*, II*, III* (see FIG. 5b). Compared with the outline representation of the device in FIG. 1, the sequence of the arrangement of the zones I*, II*, III* is in this case reversed. The magnetic roller 2 of FIG. 5 consequently rotates clockwise in operation, and the particles 4 to be aligned become arranged above the aligning body 1 in the paste-like material 3.

The magnetic roller 2 is itself subdivided into two 180° sectors 14, 15 with a central interface D. The sector 14 is in turn subdivided into two 90° sectors 14a, 14b. Arranged in the sector 14a, there is a strong permanent magnet 16 which extends at a right angle from the interface D in the direction of the opposite circumferential surface of the magnetic roller 2, so that its north pole lies in the region of the circumferential surface of the magnetic roller 2. In the sector 14b placed next to it, a weaker second permanent magnet 17 is arranged parallel to the first magnet 16 but oppositely oriented. The two magnets 16, 17 preferably consist of an NdFeB alloy and are matched in respect of their outer end faces to the curvature of the circumferential surface of the magnetic roller 2. The intermediate spaces lying between the magnets 16, 17 are filled with a nonmagnetic material, for example aluminium. The second 180° sector 15 consists entirely of a soft magnetic material, preferably a soft unalloyed steel.

The effect of this magnet arrangement in respect of the field line profile is represented in FIG. 5b. Accordingly, the sub-field generated by the strong magnet 16 in the first zone I* exerts a particularly long-range attracting force on the magnetisable particles which are contained in the material around the magnetic roller 2, or the aligning body 1. The sub-field of the second zone II* is weaker than that of the first zone I*, but is therefore preferably suitable for transporting the particles attracted by the magnetic field of the first zone I* to the release position, while aligning them in the desired way. The soft magnetic material of the sector 15 ensures that the returning field lines of the poles of the magnets 16, 17 are approximately fully enclosed in the sub-field of the third zone III* so that, outside this, virtually no more force acts on the particles and they can therefore be released easily in the aligned position.

The particular advantage of this asymmetric magnet arrangement is the long range of the attracting force with a comparatively simple structure which is cost-effective to produce.

FIGS. 6 and 7 show advantageous refinements of the magnet arrangement of FIG. 5.

In the Bucking pole arrangement represented in FIG. 6, the magnets 16, 17 are spatially connected by a further transversely arranged magnet 19, the north pole of this magnet 19 pointing towards the strong magnet 16 of the first zone I*. This arrangement makes it possible to further increase the range of the sub-field of the first zone I*, so that magnetisable particles can be attracted from an even greater distance.

The arrangement of FIG. 7 is likewise based on the asymmetric magnet arrangement of FIG. 5. In addition to the two magnets 16, 17 and the transversely arranged magnet 19, the 180° sector 14 contains two further transversely arranged magnets 20, 21, which abut with the respective outer long sides of the magnets 16, 17 and are aligned so that the north pole respectively faces the strong magnet 16 and the south pole faces the weaker magnet 17. The arrangement, thus consisting of five magnets 16, 17, 19, 20, 21 in all, corresponds to that of a linear Halbach array. It is advantageous in two regards. On the one hand, the range of the attracting force of the sub-field of the first zone I* is maximised relative to the Bucking pole arrangement. On the other hand, it allows complete screening of the rear region (zone III*), so that the field strength of the sub-field of the third zone III* vanishes. This optimises the release of the magnetisable particles in the desired position.

The arrangement with a Bucking pole or Halbach array can likewise be implemented in the dipole arrangement with a radial magnet alignment, for example according to FIG. 4, and improves its effect in respect of the attraction and alignment of the magnetisable particles.

A further embodiment of the invention is represented in FIGS. 8 and 9. Here, the magnetic roller 2* is equipped with a number of permanent magnets 22a-22e, preferably made of NdFeB, arranged behind one another in the axial direction of the roller 2*. The block-shaped magnets 22a-22e, which are therefore particularly cost-effective to produce, again form a linear Halbach array which, in this exemplary embodiment in contrast to those described above, is aligned in the axial direction of the magnetic roller 2*. Correspondingly, the field lines extend strictly in the axial direction of the roller 2*, that is to say in a plane perpendicular to the relative motion between the aligning body 1 and the paste-like material 3 (see FIG. 2). The magnetic roller according to FIG. 8 forms a magnetic field consisting of two zones I**, II**, in which the sub-field of the first zone I** exerts a long-range force on the particles present in the paste-like material and the vanishing sub-field of the second zone II** releases the particles approximately at the position 1e of the aligning body.

The magnets 22a-22e are fastened on a roller block 23 with a semicircular cross section. The roller block 23 preferably consists of a magnetic steel with high permeability.

The particular advantage of this axial arrangement of the magnets, which may likewise be arranged in the form of a Bucking pole, is now that owing to the axial profile of the magnetic field lines (see FIG. 9) they do not spread in the circumferential direction of the magnetic roller, i.e. the magnetic field is strictly limited in the circumferential direction. Network formation does not therefore take place between the magnetisable particles in the circumferential direction of the magnetic roller, which would impede regular detachment of the aligned particles. Furthermore, the axial field line profile leads to a particularly extended zone in which the magnetic field vanishes, which in turn facilitates release of the aligned particles.

Lastly, FIGS. 10 and 11 represent another embodiment of the invention. Here, the magnetic roller 2** is equipped in a recurring sequence with permanent magnets 24a, 24b, 25, preferably made of NdFeB, so that two neighbouring magnets 24a, 24b of identical orientation, arranged symmetrically with respect to the longitudinal axis, respectively alternate along the longitudinal axis of the magnet unit with a stronger centrally placed magnet 25 of oppositely aligned orientation. The magnets 24a, 24b, 25 are again fastened on a roller block 26 with a semicircular cross section. The roller block 26 preferably consists of a magnetic steel with high permeability. FIG. 11 represents the field line profile of the magnet unit 2** according to the invention, projected onto the observation plane. As represented, the field lines extend from the north pole of the centrally placed magnet 25 to the south poles of the magnets 24a, 24b arranged next to each other and offset relative to the magnet 25. On the one hand, as can be seen in FIG. 11, the field lines therefore have components aligned perpendicularly to the longitudinal axis of the magnet unit 2** and therefore extend in a plane parallel to the relative motion between the aligning body and the paste-like material. On the other hand, they also have components extending in the axial direction so that the axial offset between the magnet pairs 24a, 24b and the central magnet 25 is bridged.

The particular advantage of such a magnet arrangement is that the aligned particles are distributed particularly uniformly in the target volume, and no longer have any tendency towards clumped accumulation along field lines which extend only parallel or perpendicularly to the relative motion between the aligning body and the paste-like material.

The invention is not restricted to the exemplary embodiments which have been described; rather the person skilled in the art may find many possibilities for derivation or modification in the scope of the invention. In particular, the protective scope of the invention is established by the claims.

1-21. (canceled)

22. A device for aligning magnetizable particles in a kneadable material, the device comprising:
a. an aligning body including a front surface section and a rear surface section, the aligning body being movable through the kneadable material with the front surface section leading the rear surface section;
b. a magnet unit within the front surface section, the magnet unit generating a periodically varying magnetic field suitable for aligning any magnetizable particles within the kneadable material, wherein the magnetic field generated by the magnet unit:
(1) has field lines extending in planes perpendicular to the relative motion between the aligning body and the kneadable material, and
(2) comprises at least two zones having sub-fields of different field strength and/or field line profile wherein:
(a) the sub-field of the first zone exerts an aligning force on the magnetizable particles within the kneadable material, and
(b) the sub-field of the second zone releases the aligned magnetizable particles within the kneadable material.

23. The device of claim 22 wherein the field lines of the magnetic field of the magnet unit also extend in planes parallel to the relative motion between the aligning body and the kneadable material.

24. The device of claim 23 wherein the wherein the magnetic field generated by the magnet unit comprises three zones having sub-fields of different field strength and/or different field line profile wherein:
(1) the sub-field of the first zone exerts an attracting force on any magnetizable particles within the kneadable material,
(2) the sub-field of the second zone exerts a holding and aligning force on any magnetizable particles within the kneadable material, and
(3) the sub-field of the third zone releases any magnetizable particles within the kneadable material in the aligned position.

25. The device of claim 24 wherein the sub-field of the third zone is generated by a soft magnetic material.

26. The device of claim 25 wherein the soft magnetic material is a low-carbon steel.

27. The device of claim 24 wherein the magnetic field is generated by a tripole system.

28. The device of claim 24 wherein the magnetic field is generated by a dipole system having a radial arrangement.

29. The device of claim 24 wherein:
a. the first and second zones each cover approximately a 90° region of the cross section of the magnet unit, and
b. the third zone approximately covers a 180° region of the cross section of the magnet unit.

30. The device of claim 24 wherein the three zones each cover approximately a 120° sector of the cross section of the magnet unit.

31. The device of claim 22 wherein the magnet unit is defined by a rotating body with a static field distribution.

32. The device of claim 22 wherein:
a. the front surface section is curved,
b. a pair of flank surfaces extend therefrom toward the rear surface section, with the flank sections converging toward each other as they extend toward the rear surface section.

33. The device of claim 32 wherein the magnet unit is defined by a rotating cylindrical roller situated between the flank surfaces and within the curve of the front surface section, and wherein the rotational axis of the roller is situated along a plane bisecting the front surface section.

34. The device of claim 22 wherein the magnetic field of the magnet unit is generated by permanent magnets.

35. The device of claim 34 wherein at least one of the permanent magnets consists of an NdFeB alloy.

36. The device of claim 22 wherein the magnetic field is generated by a Bucking pole arrangement.

37. The device of claim 22 wherein the magnetic field is generated by a Halbach array.

38. A method for aligning magnetizable particles in a kneadable material comprising the step of moving the device of claim 1 within kneadable material.

39. The method of claim 38 wherein the kneadable material is unset concrete.

40. The method of claim 38 wherein the magnetizable particles include steel fibers.

41. The method of claim 38 wherein the magnetizable particles include steel rings.

42. A device for aligning magnetizable particles in a kneadable material, the device comprising:
a. an aligning body including a front surface section and a rear surface section, the aligning body being movable through the kneadable material with the front surface section leading the rear surface section;
b. a magnet unit within the front surface section, the magnet unit generating a periodically varying magnetic field suitable for aligning any magnetizable particles within the kneadable material, wherein the magnetic field generated by the magnet unit:
(1) has field lines extending in planes parallel to the relative motion between the aligning body and the kneadable material, and
(2) comprises zones having sub-fields of different field strength and/or different field line profile wherein:
(a) a first zone has a sub-field exerting an attracting force on the magnetizable particles within the kneadable material,
(b) a second zone has a sub-field exerting a holding and aligning force on the magnetizable particles within the kneadable material, and
(c) a third zone has a sub-field releasing the magnetizable particles within the kneadable material in the aligned position.
